(19) United States
(12) Patent Application Publication
(10) Pub. No.: US 2013/0292284 A1
(43) Pub. Date: Nov. 7, 2013

(54) SHIPPING CONTAINER END PANELS

(71) Applicants: Todd M. Burke, Waxhaw, NC (US); Donn J. Costanzo, JR., Fort Mill, SC (US)

(72) Inventors: Todd M. Burke, Waxhaw, NC (US); Donn J. Costanzo, JR., Fort Mill, SC (US)

(21) Appl. No.: 13/839,822

(22) Filed: Mar. 15, 2013

Related U.S. Application Data
(60) Provisional application No. 61/642,448, filed on May 3, 2012.

(51) Int. Cl. B65D 85/672; B31B 17/00

(52) U.S. Cl. CPC B65D 85/672; B31B 17/00
USPC 206/408; 493/391

(57) ABSTRACT

An end panel includes one or more core support members and a folded sheet of corrugated material, wherein the ripples or troughs that extend from top to bottom for vertically supporting an article received within a generally oval opening of the end panel.

### CROSS-REFERENCE TO RELATED APPLICATION

The present application is a U.S. nonprovisional patent application of, and claims priority under 35 U.S.C. §119(e) to, U.S. provisional patent application Ser. No. 61/642,448, filed May 3, 2012, which provisional patent application is incorporated by reference herein. A copy of the disclosure of the '448 provisional application is contained in the Appendix, which is incorporated herein by reference as well.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to shipping containers and, in particular, to end boards used in packages and shipping containers designed to support generally cylindrical articles such as, for example, rolls of industrial tape.

Exhibit A of the Appendix, which is incorporated by reference herein, discloses a conventional shipping container for shipping industrial rolls of tape, which comprises open cell honeycomb board with edge protectors and is represented by “Sample Description 2” on page 1 and indicated by callout “D” in the photographs of page 2 (hereinafter “Open Cell Honeycomb Design”). It has been found that the Open Cell Honeycomb Design delaminates when sent overseas in humid environments.

In addition, three other designs are set forth in and tested in comparison with the Open Cell Honeycomb Design in Exhibit A. These three other designs include: “Sample Description 1” on page 1 and indicated by callout “A” in the photographs of page 2 (hereinafter “One and One-Half Inch Fiber Core Design”); “Sample Description 3” on page 2 and indicated by callout “A” in the photographs of page 2 (hereinafter “One Inch Fiber Core Design”); and “Sample Description 4” on page 2 and indicated by callout “D” in the photographs of page 2 (hereinafter “Corrugated with Tube Design”).

As revealed in the test results disclosed in Exhibit A, the Corrugated with Tube Design outperformed the other designs and represents an improvement over the other designs. The Corrugated with Tube Design is representative of a preferred embodiment in accordance with the present invention and is now described in greater detail.

### SUMMARY OF THE INVENTION

The present invention includes many aspects and features. Moreover, while many aspects and features relate to, and are described in, the context of end panels of shipping containers for generally cylindrical articles and the like, including such things as rolls and tubes, the present invention is not limited to use only in such context, as will become apparent from the following summaries and detailed descriptions of aspects, features, and one or more embodiments of the present invention. Moreover, while the present invention is described with reference to shipping containers, the present invention is just as applicable to packaging and packages for transporting or storing cylindrical articles and the like, including such things as rolls and tubes.

Accordingly, one aspect of the present invention relates to an end panel having one or more core support members and corrugations with ripples or troughs that extend from top to bottom of the sides of the shipping container for supporting an article received within a generally oval opening of the end panel.

Another aspect comprises a method of making the end panel by combining core support members with a folded sheet of material. Two core support members preferably are included, and the material is preferably corrugated.

Another aspect comprises a method of using an end panel in accordance with one or more aspects of the present invention.

Another aspect comprises a shipping container having end panels in accordance with one or more aspects of the present invention.

It will be appreciated that further aspects and features are disclosed elsewhere herein.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

One or more preferred embodiments of the present invention now will be described in detail with reference to the accompanying drawings.

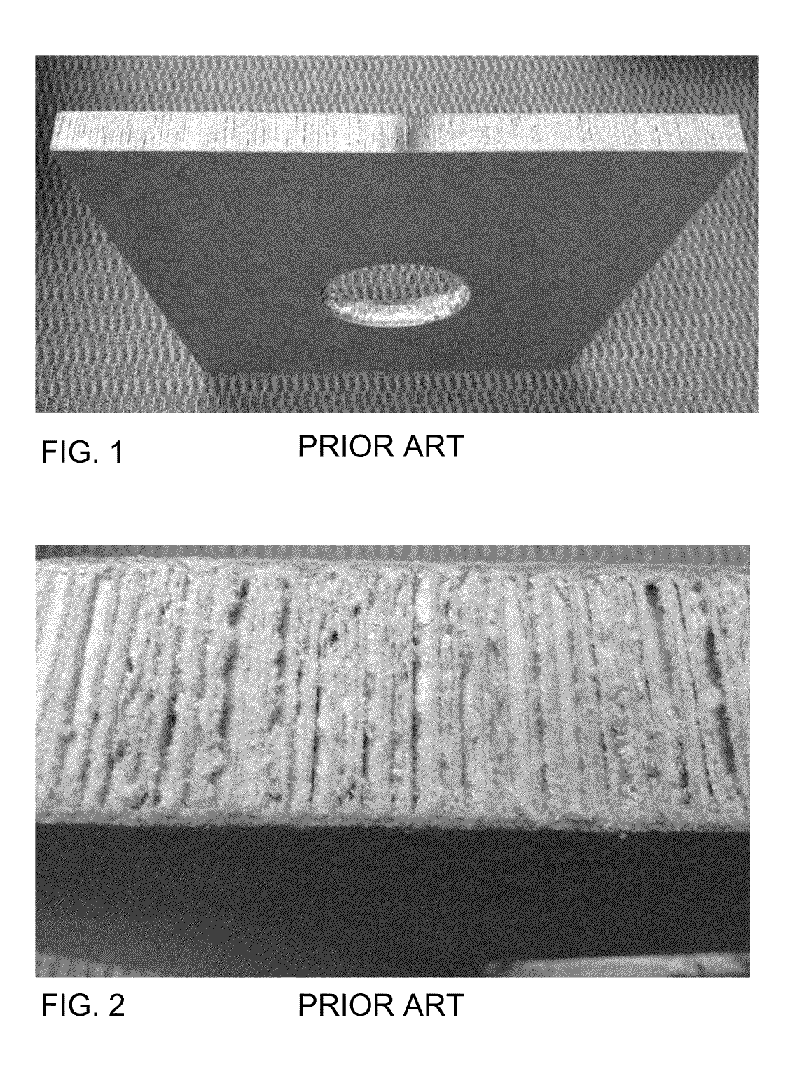

FIG. 1 is a perspective top view of an end panel in accordance with the prior art.

FIG. 2 is a close up of the top of the end panel of FIG. 1 and serves to illustrate the construction of the end panel thereof.

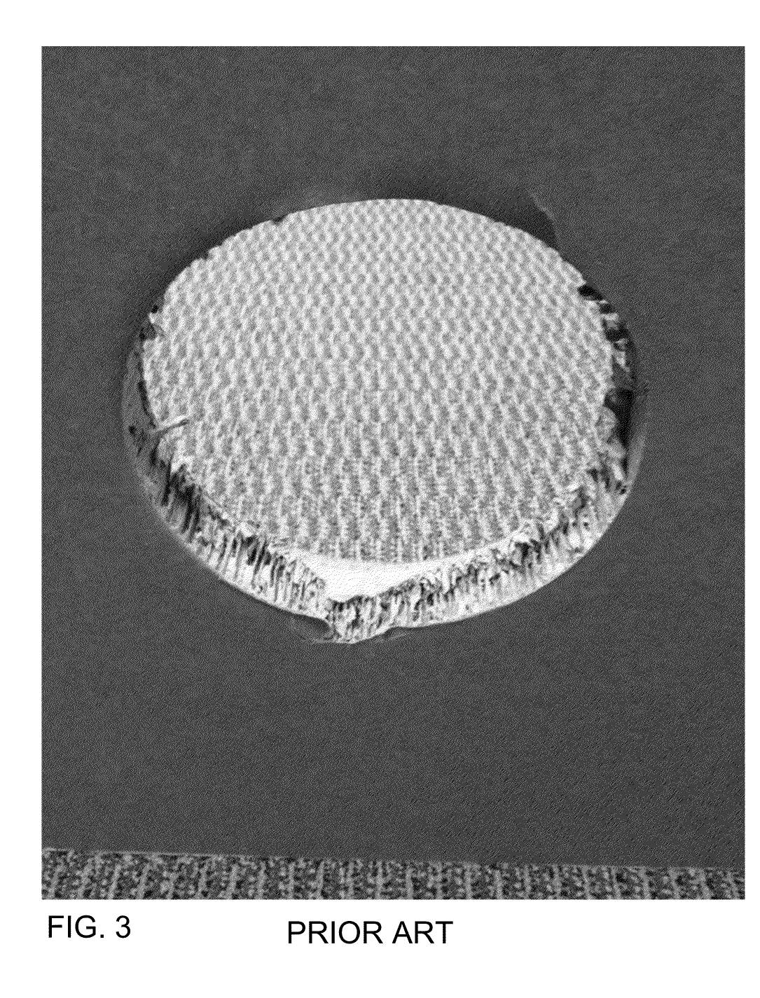

FIG. 3 is a close up of the opening in the end panel for receiving an end of a generally cylindrical article. Damage that can result to the end panel when the end panel fails to adequately support an article is shown in FIG. 3.

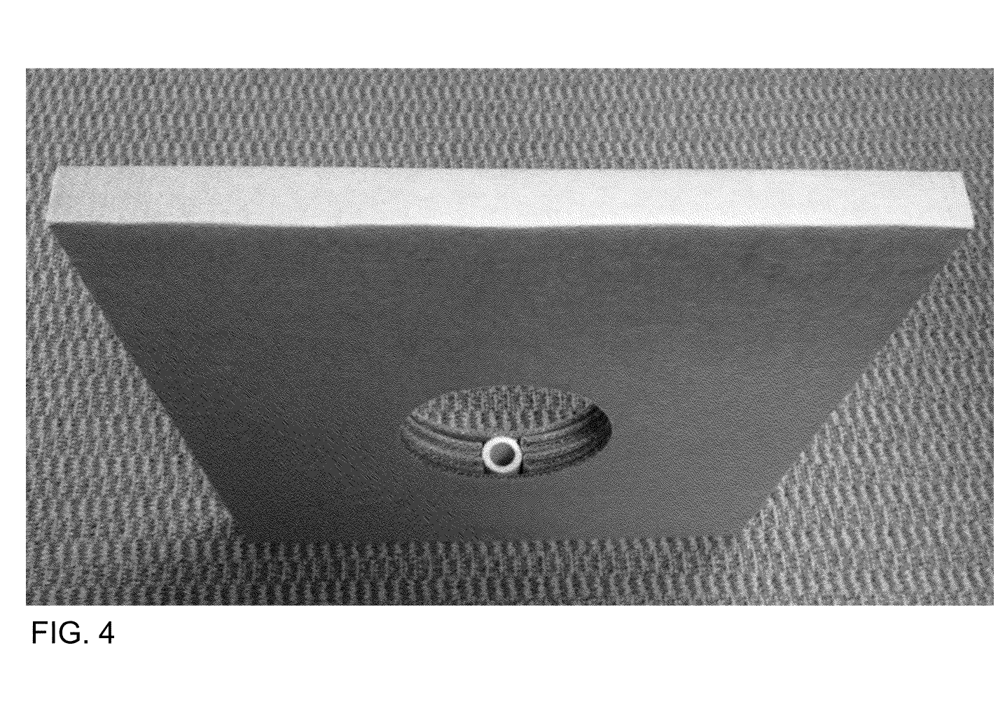

FIG. 4 is a perspective top view of an end panel in accordance with a preferred embodiment of the present invention.

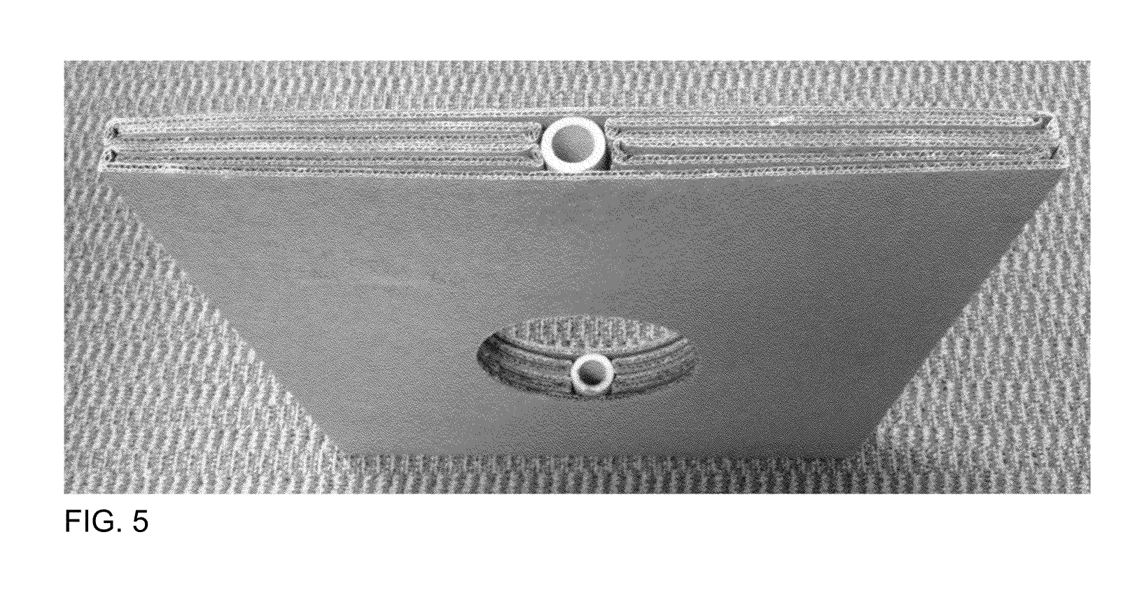

FIG. 5 is a perspective bottom view of the end panel of FIG. 4.

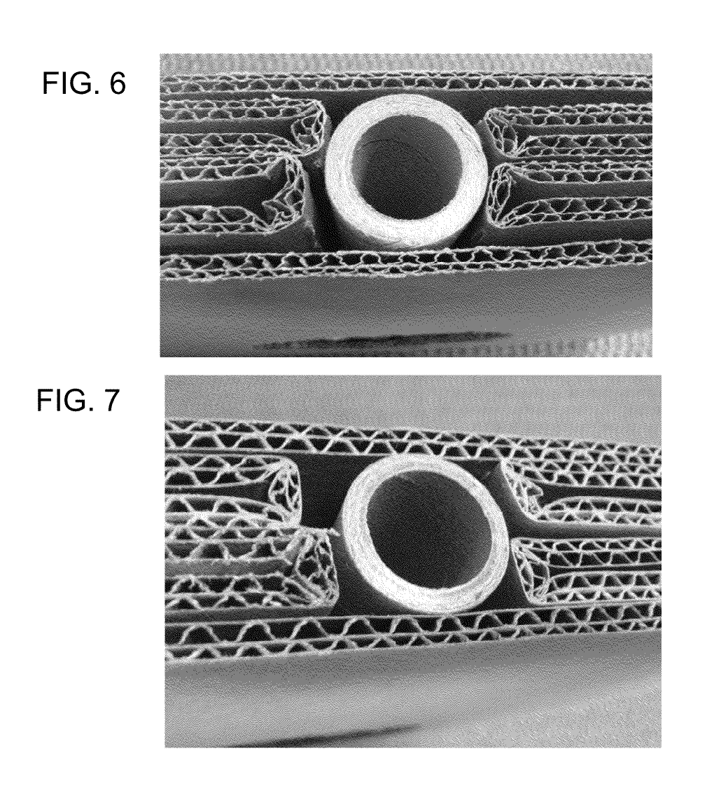

FIG. 6 is a close up view of a middle portion of the bottom of the end panel of FIG. 4, whereat an end of a core support member is illustrated.

FIG. 7 is another view similar to FIG. 6.

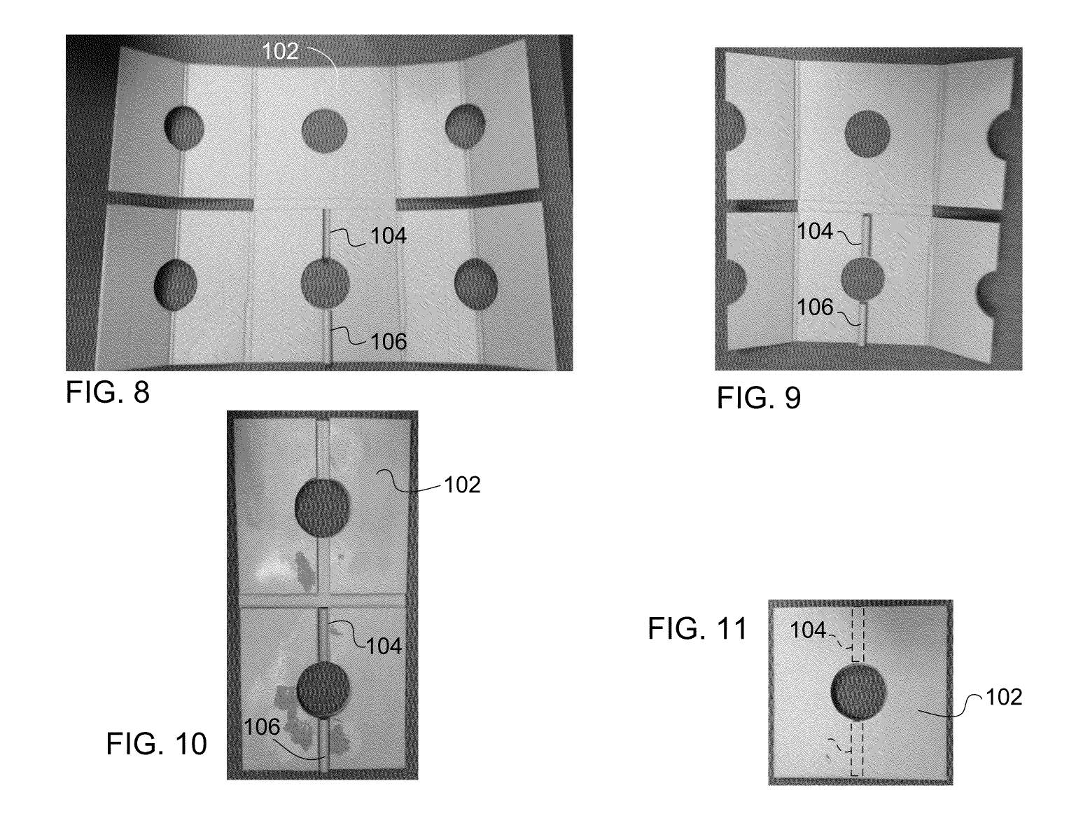

FIG. 8 is a perspective view of the end panel of FIG. 4 in a completely unfolded configuration. As will be appreciated, the end panel comprises a generally planar sheet of corrugated material 102—sometimes referred to herein as a blank—that is folded along predetermined fold lines and two core support members 104,106. Some bending is reflected in the view of FIG. 8 because the end panel has actually been unfolded from the folded configuration shown in FIG. 4.

FIG. 9 is a perspective view of the end panel of FIG. 4 in a first partially folded configuration. Folding of the end panel shown in the completely unfolded configuration of FIG. 8 results in the partially folded configuration of FIG. 9.

FIG. 10 is a perspective view of the end panel of FIG. 4 in a second partially folded configuration. Folding of the end panel shown in the partially folded configuration of FIG. 9 results in the partially folded configuration of FIG. 10.

FIG. 11 is a perspective view of a side of the end panel of FIG. 4 in a completely folded configuration. Folding of the end panel shown in the partially folded configuration of FIG. 10 results in the completely folded configuration of FIG. 11.

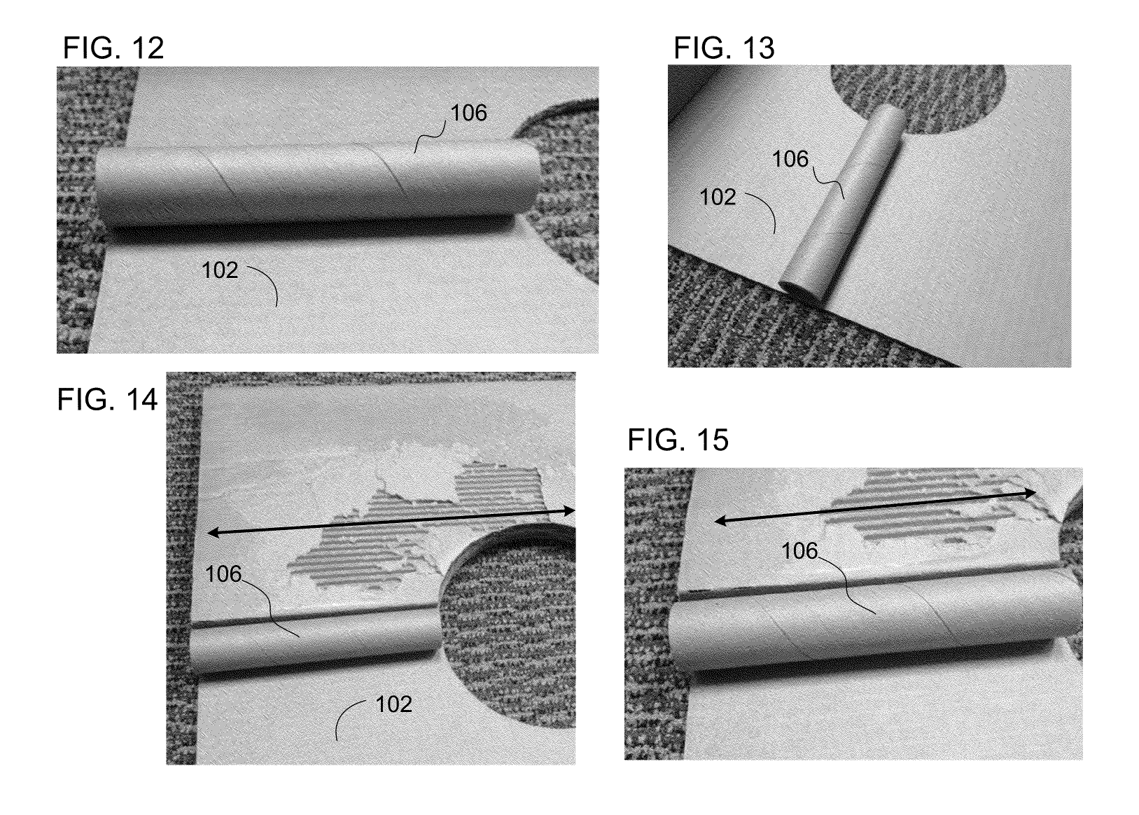

FIG. 12 is a perspective view of core support member 106, which is preferably adhered to the sheet 102 of corrugated material.

FIG. 13 is another perspective view of core support member 106 and sheet 102. Moreover, FIG. 13 shows the direction of corrugation of the sheet material, the lines of which extend generally in parallel to the axis of the core support member 106.

FIG. 14 is another perspective view of core support member 106 and sheet 102, and includes a partially broken away section of the sheet 102 showing the corrugations in the material of the sheet 102. A line is included that extends in parallel to the ripples (or troughs) of the corrugated material.

FIG. 15 is another perspective view of core support member 106 and sheet 102, and includes another partially broken away section of the sheet 102 showing the corrugations in the material of the sheet 102. Another line similar to that of FIG. 14 is included extending in parallel to the ripples (or troughs) of the corrugated material.

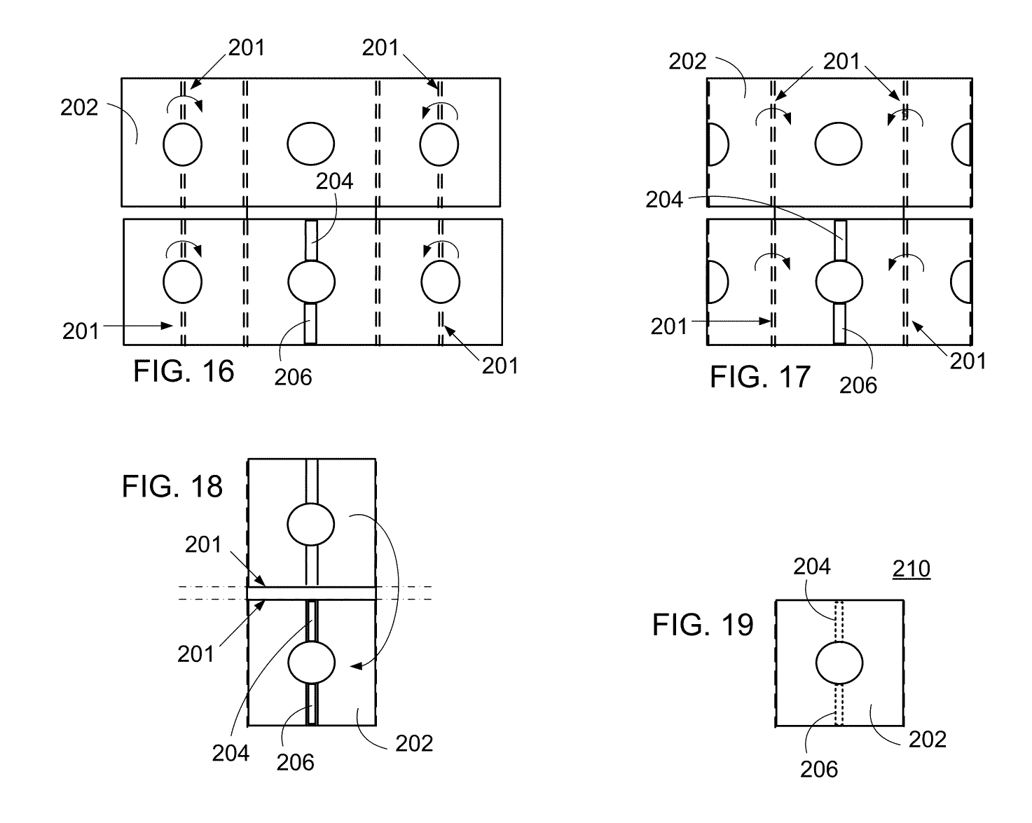

FIG. 16 is a plan view of a generally planar sheet 202 of material (preferably corrugated) having predetermined fold lines 201. Two core support members 204,206 are also shown. A step in folding the sheet 202 so as to make an end panel 210 in accordance with a preferred embodiment of the invention is illustrated by the arrows extending about fold lines 201 in FIG. 16.

FIG. 17 is a plan view of the sheet 202 in a partially folded configuration following the folding represented by the arrows in FIG. 16. Similarly, a further step in folding the sheet 202 so as to make end panel 210 is illustrated by the arrows extending about the fold lines 201 in FIG. 17.

FIG. 18 is a plan view of the sheet 202 in another partially folded configuration following the folding represented by the arrows in FIG. 17. Similarly, yet a further step in folding the sheet 202 so as to make end panel 210 is illustrated by the arrows extending about the fold lines 201 in FIG. 18.

FIG. 19 is a plan view of the end panel 210 resulting from the folding steps illustrated in FIGS. 16-18.

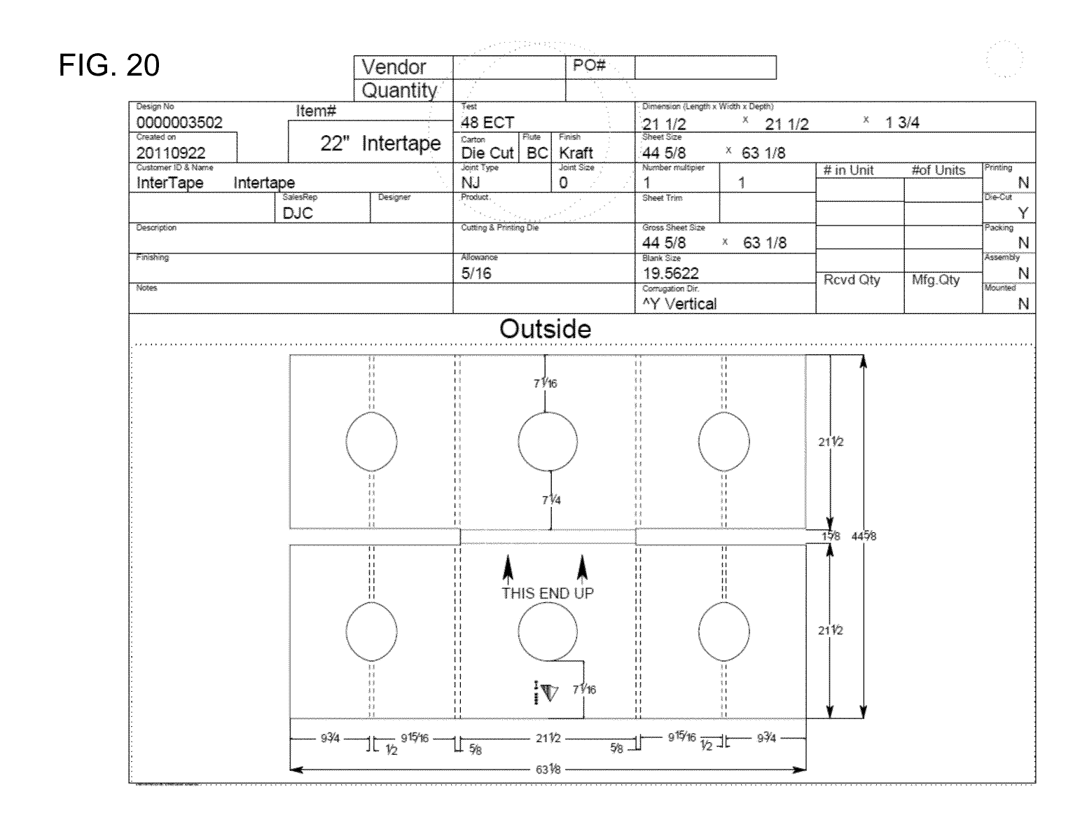

FIG. 20 is a schematic illustration of a sheet (one of the components of an end panel) including dimensions thereof for a preferred embodiment of the present invention. Core members (the other components of the end panel) are not shown in FIG. 20.

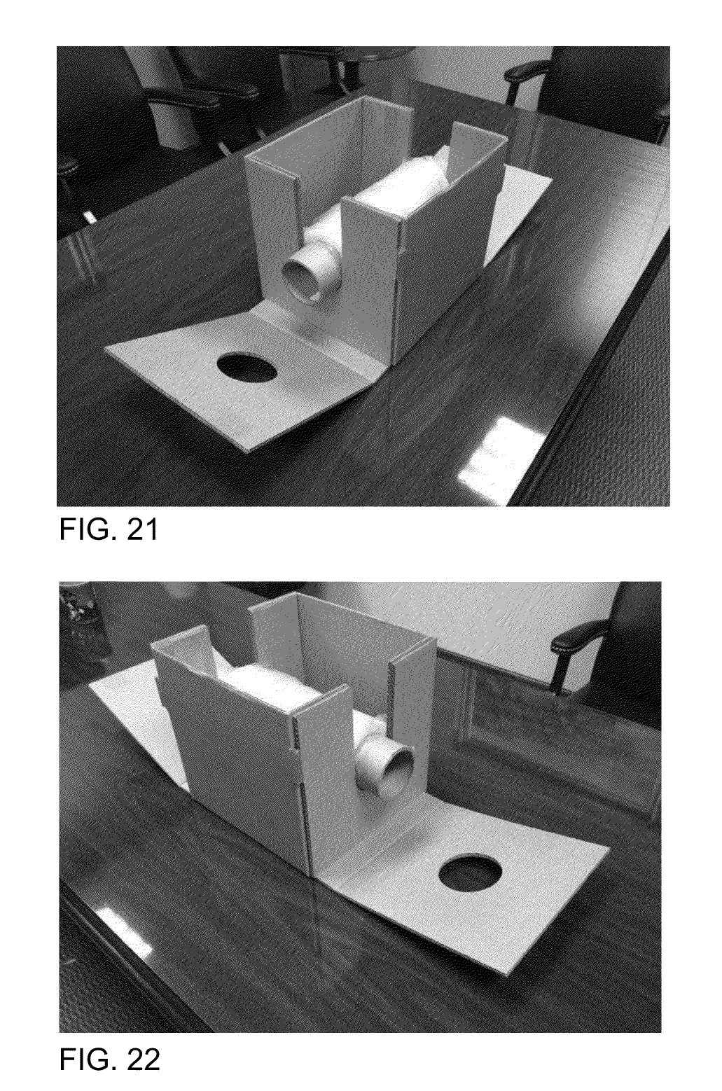

FIG. 21 is a perspective view of a box or shipping container for a generally cylindrical article, shown here to be a roll of stretch wrap material. The shipping container shown is constructed for use with end panels.

FIG. 22 is another perspective view of the shipping container and roll supported therein of FIG. 21.

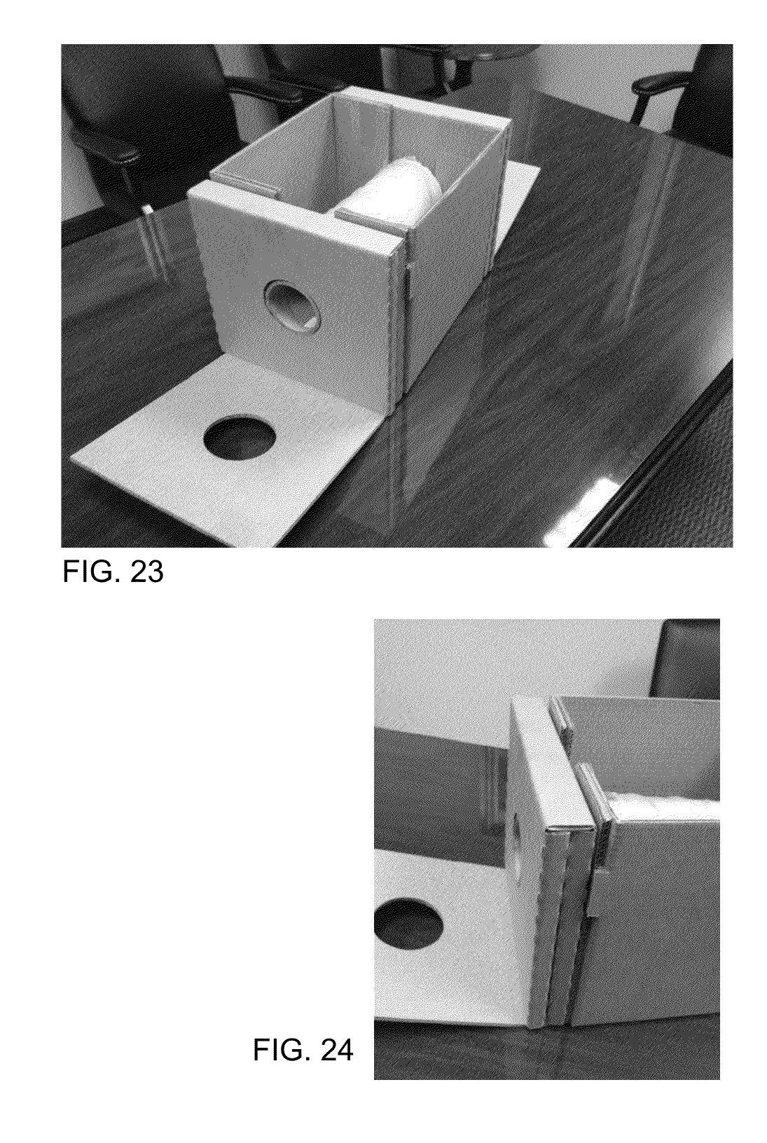

FIG. 23-24 is a perspective view of the shipping container and roll in conjunction with a preferred end panel of the present invention, such as that shown in FIGS. 4-15. As can be seen, the end of the tube is received within the oval opening of the end panel.

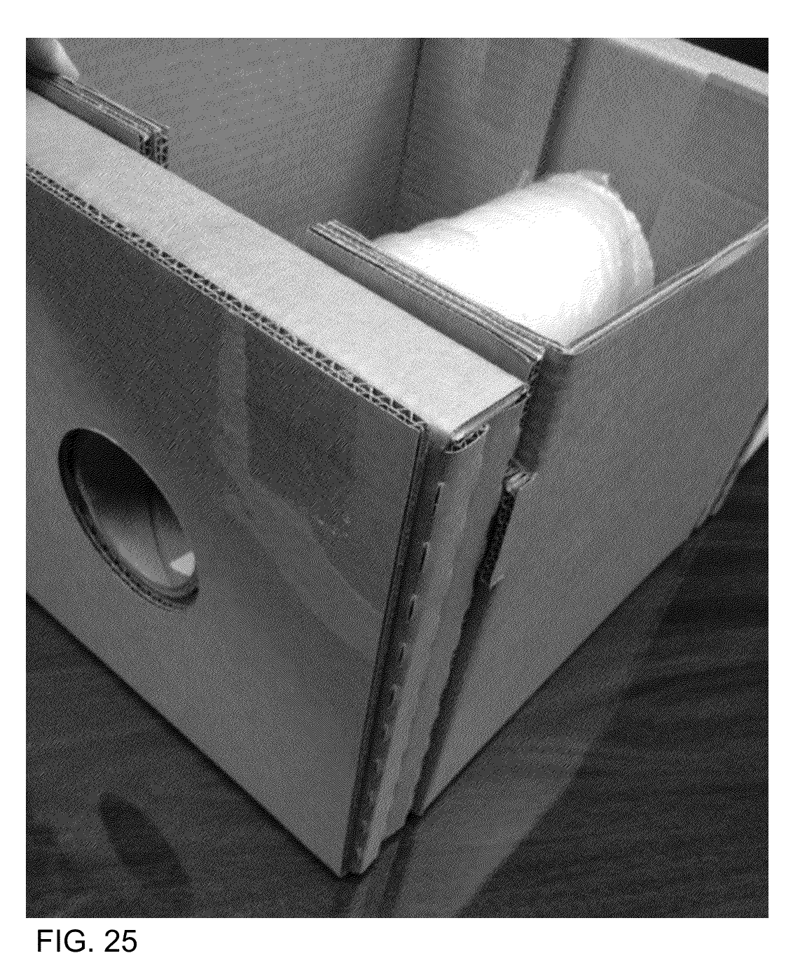

FIG. 25 is a close up perspective view of the end panel received between an outer wall of the shipping container and an inner wall of the shipping container. The end panel may be glued or otherwise adhered to the one or both of these walls of the shipping container. Alternatively, the end panel may be taped or otherwise fastened, such as with a clip or bracket and, in particular, a U-shaped or C-shaped clip. The clip may be spring biased into a closed position.

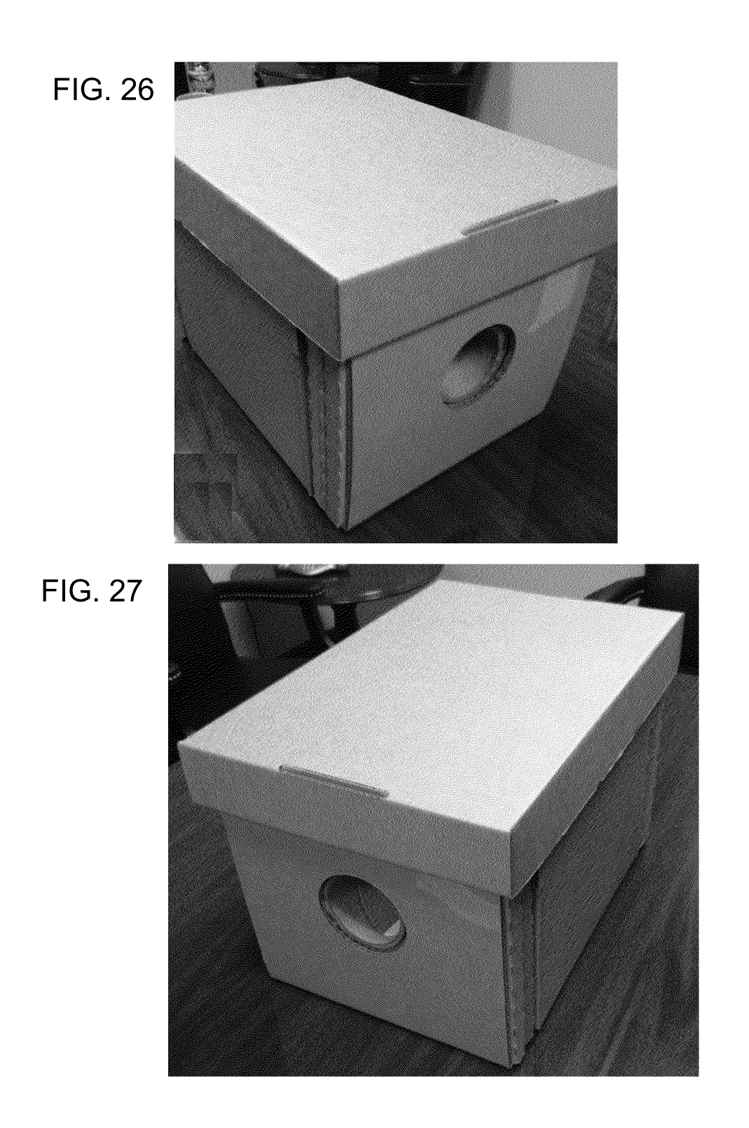

FIGS. 26-27 each is a perspective view of the shipping container and roll of FIG. 25 after another preferred end panel has been installed and a lid has been positioned over the top of the shipping container extending between and encompassing the opposite side walls of the shipping container, including the end panels.

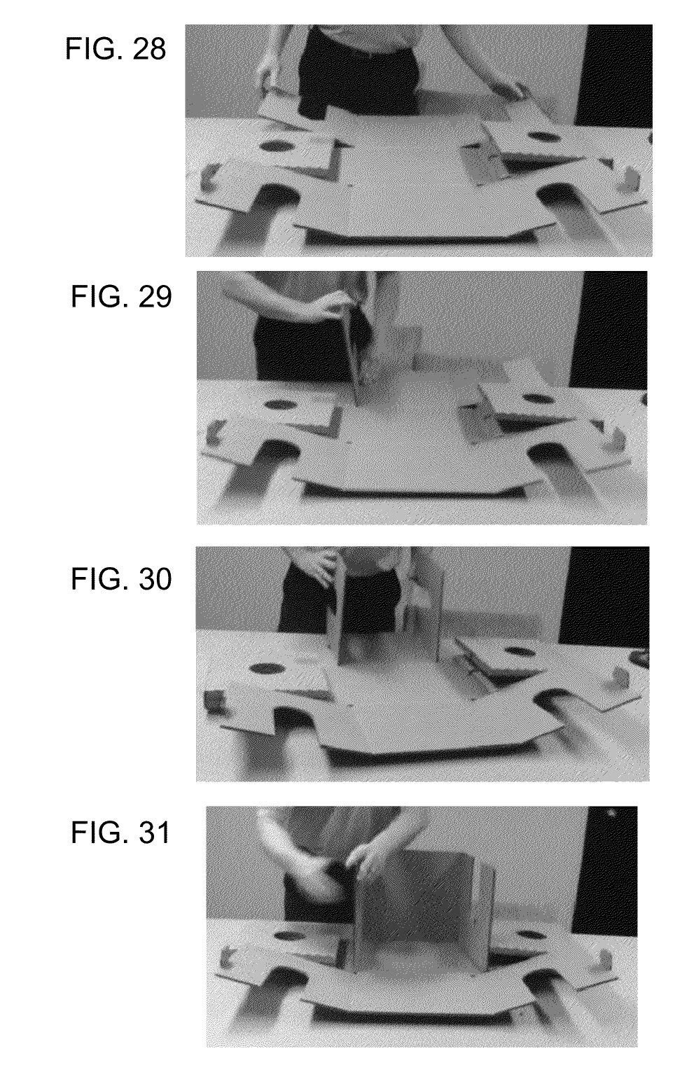

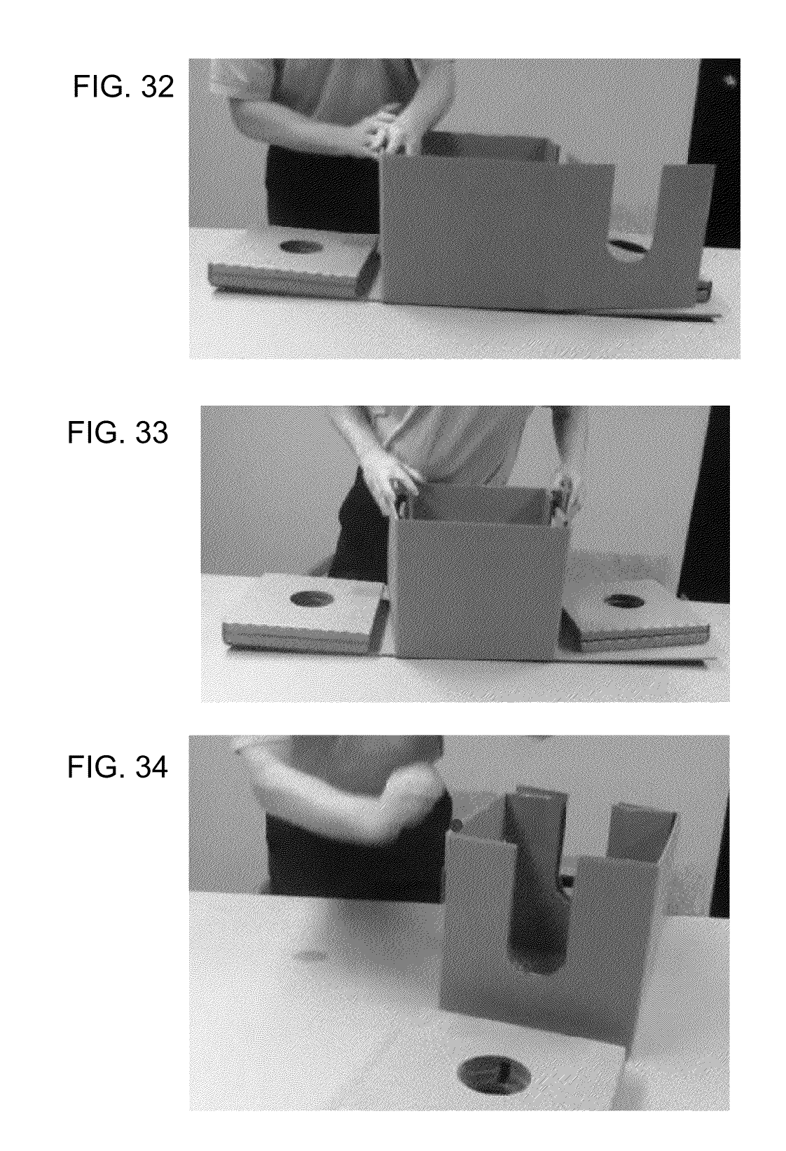

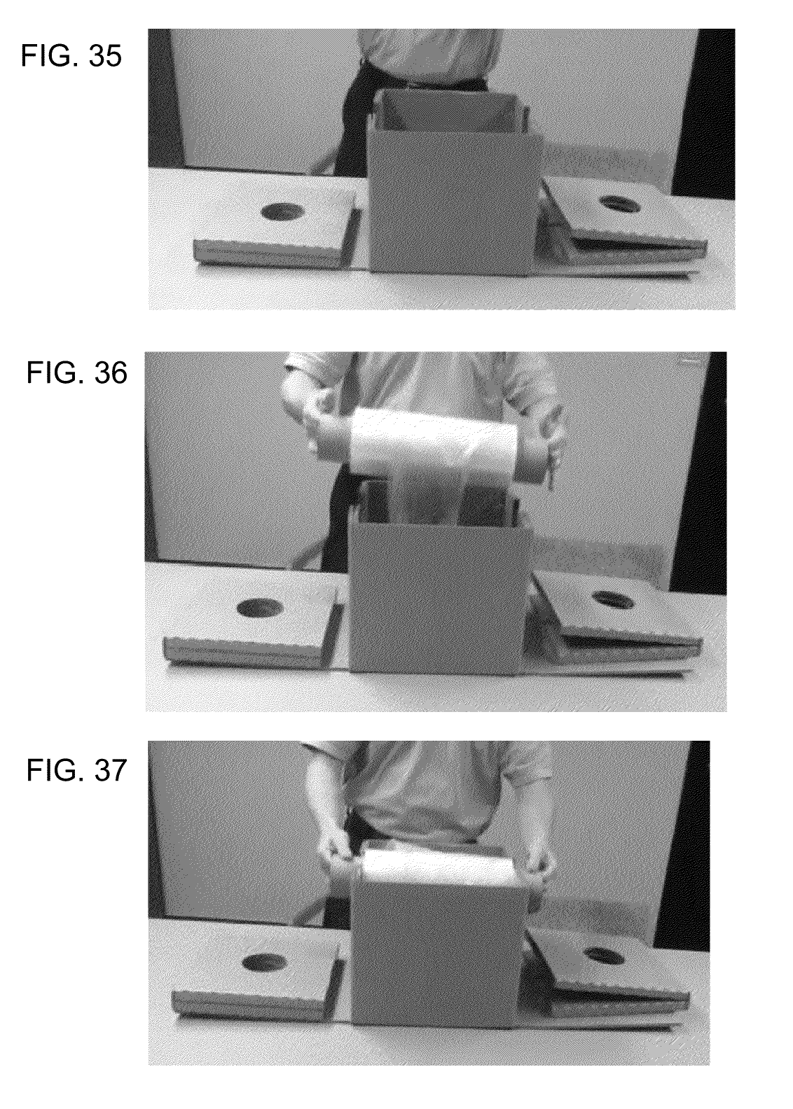

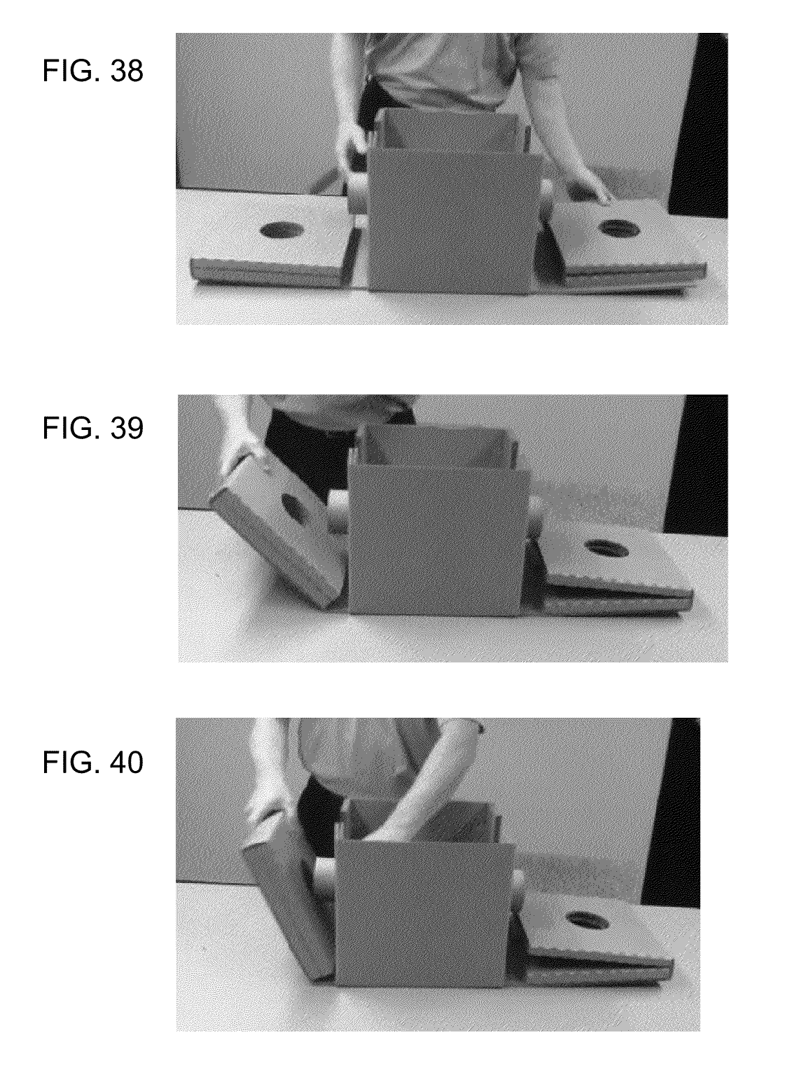

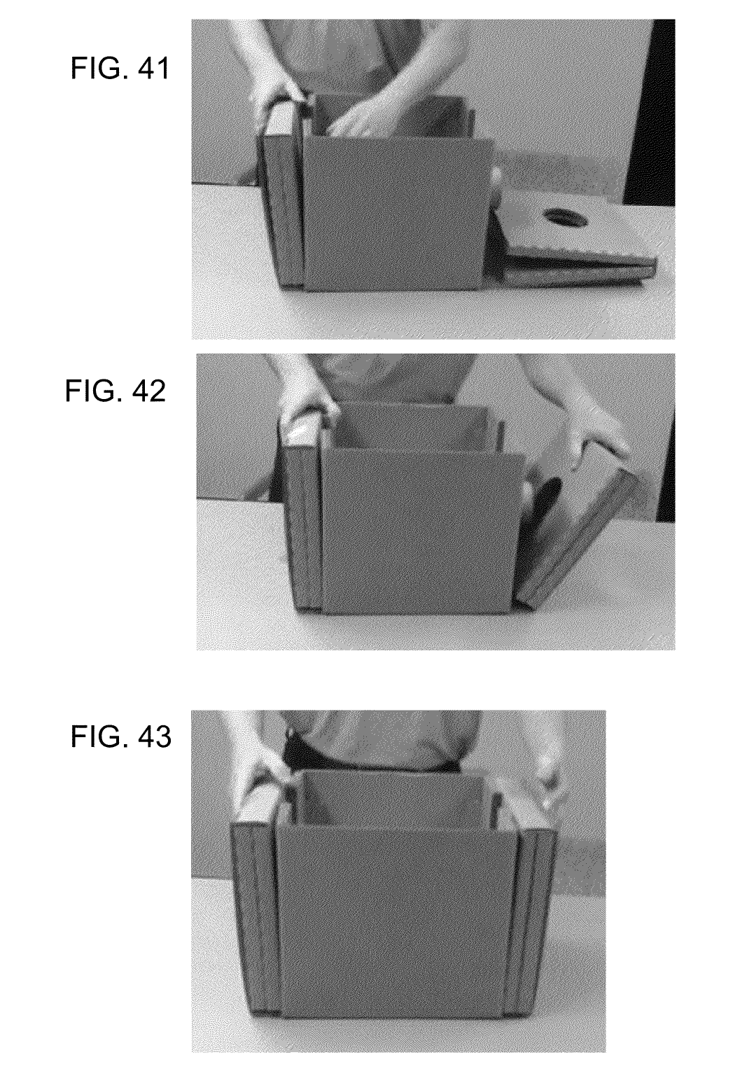

FIGS. 28-43 illustrates the steps of placing a roll into the shipping container and inserting the ends of the tube of the roll into end panels. The end panels are already constructed as shown in FIG. 28, and the steps begin with the constructing of the shipping container from a blank (the end panels as shown are merely resting on the interior surfaces of the shipping container's end side walls. Additionally, each end panel is constructed from folding a sheet of corrugated material, with the ripples or troughs of the corrugation running from top-to-bottom with respect to the outer side walls of the shipping container. Moreover, core support members are not included as shown; however, while such end panels are contemplated in accordance with the present invention, core support members are utilized in preferred embodiments of the invention. Indeed, it is believed that the direction of the corrugation provides vertical stacking strength in supporting the article received within the opening of the end panel as well as supporting other items placed on top of the shipping container; however, it is believed that the core support members as shown in the prior figures provide even additional strength and such additional strength is desired in preferred embodiments.

With respect to a particular advantage of one or more preferred embodiments, it is believed that the end panels are cost effective, easy to construct (as shown herein), strong, and 100% recyclable (and thus ‘green’ or ecofriendly). Moreover, because corrugated material of the folded sheet material is the primary component, together with the core support members (which are also preferably constructed from paper or cardboard, or similar material), shipping and transit issues associated with heat treated wood and splinters are avoided.

Other material from which the core support members could be made in accordance with the invention include piping, wood blocks, dowel rods, all of which are believed to be sufficiently strong enough and inexpensive enough to support the roll weight along with being recyclable (which is preferred).

Based on the foregoing description, it will be readily understood by those persons skilled in the art that the present invention is susceptible of broad utility and application.

Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1-4. (canceled)

5. An end panel comprising one or more core support members and a folded sheet of corrugated material, wherein the ripples or troughs of the corrugations extend from top to bottom for vertically supporting an article received within a generally oval opening of the end panel or placed on top of the shipping container, wherein the core support members are elongate, and wherein a longitudinal axis of the core support members extends generally in parallel with the ripples or troughs of the corrugation.

6. The end panel of claim 5, further comprising a core support member.

7. The end panel of claim 5, further comprising two core support member axially aligned with one another.

8. A method of making an end panel by combining core support members with a folded sheet of material.

9. The method of claim 8, wherein two core support members are used, and wherein the material is preferably corrugated.

10. An end panel made from the method of claim 8.

11. An end panel made from the method of claim 9.
